(19) United States
(12) Patent Application Publication
(10) Pub. No.: US 2017/0021838 A1
(43) Pub. Date: Jan. 26, 2017

(54) MOBILE DEVICE AND SOFTWARE FOR IMPROVING OCCUPANCY DURING A WORKDAY COMMUTE

(71) Applicant: Edward Clark Fontana, Rockwall, TX (US)

(72) Inventor: Edward Clark Fontana, Rockwall, TX (US)

(21) Appl. No.: 15/219,224

(22) Filed: Jul. 25, 2016

Related U.S. Application Data
(60) Provisional application No. 62/196,971, filed on Jul. 25, 2015.

(51) Int. Cl. B60W 50/08; B60W 10/30; G05D 1/00

(52) U.S. Cl. CPC B60W 50/08; G05D 1/0088; B60W 10/30; B60W 2540/00

(57) ABSTRACT

A set of software assisted features is described that enhance a workday commute to attract passengers. These include: use of an eye datum to position drivers away from the firewall, dual diagonal cooling systems that apply full cooling force as the sun clocks around the vehicle, software controlled exterior locker doors allowing a vehicle to act as a delivery destination at work or an autonomous errand runner, and a rear door that rotates largely in envelope and concentric with the rear axle to remove all opportunities for door dings.

### CROSS-REFERENCE TO PROVISIONAL APPLICATION

This application claims the benefit of U.S. Provisional Application No. 62/196,971 entitled “Mobile Device Software for Improving a Workday Commute” to Edward C. Fontana, filed on Jul. 25, 2015, which is incorporated herein by reference in its entirety.

### BACKGROUND

The field of the disclosure relates generally to automobiles that can be used to convey people to and from work on workday commutes, and also contain hardware and software elements. The automobile is considered a mobile device for conveying people and presenting information. A primary goal is to attract multiple people to a single vehicle and create a high occupancy vehicle workday commute.

Individuals in the United States consume twice as much energy as those in any other region. Solitary workday commutes in light vehicles are the leading reason for this difference. An electric vehicle design to help catalyze more social, higher occupancy, commuting habits can help make workday commutes less solitary.

Performance criteria for such a vehicle are: 1) attract passengers to the suburban front yard at 6:30 AM, 2) match market leading crash test performance, cargo capability, and sense of freedom, and 3) deliver easier parking, better acoustics and better passenger mile efficiency.

A vehicle as a rolling event venue determines a large windscreen, side-by-side upright seating arrangements, and acoustic excellence—an experience where there are only good seats. These requirements force a decision to close the wake along a vertical line to form a narrow wake. The chassis is platform batteries with dual motor electric rear drive and undetermined front drive.

A study into the characteristics which would support high occupancy workday commutes delivered these findings:

Narrow wake synergies include: a) cargo loading on a tailgate ramp to a low 0.3 m (12 inch) high load floor through a 0.8 m (32 inch) wide opening—as a controlled event using an onboard powered trolley, b) passengers more safely located, and c) thick rear doors that pivot concentric with the rear axle, with no chance of damaging adjacent objects.

A consistent driver's eye location, as datum, provides better forward visibility past the A-Pillar and more consistent relationships between driver, passengers and vehicle safety and content delivery systems, when compared to location off fixed pedals at the firewall.

Collateral benefits of the eye datum include large section B-Pillars, dual diagonal cooling circuits that apply full cooling power as the sun clocks, and a smooth transition to self-driving operation.

Additional characteristics of a high occupancy vehicle include the ability to complete errands when commuting as a passenger.

When people leave the house in the morning, they are often expected to come home having done more than just a day's work. Errand completion may be expected on the remote end of the day's trip. Recall that shopping consumes half as much energy as the workday commute. Energy will be saved if the long leg of shopping and commuting trips is combined.

The high occupancy vehicle discussed helps combine work trips and shopping trips in two ways since it has externally accessible lockers for each commuting passenger: 1) A delivery person treating the parked vehicle as a drop off destination can open these lockers, and 2) The lockers can also be used when the car is fully autonomous. The car can run errands while the commuting passengers work. An automotive sensor scan of a bar code from an Internet order lets the car know which locker door to open at GPS confirmed pick up points. Note: Using event windows, GPS and digital signatures to control vehicle access makes the vehicle more useful for everyone.

Having the car pick up objects during off peak traffic, while passengers are working, is consistent with our goal of reducing energy consumption. The doors to external lockers open on sensor scan.

Clearly what is needed in the art is a vehicle with low aerodynamic drag, peer seating where all occupants have equal status, good visibility and a smooth transition to the benefits of self-driving operation.

### BRIEF DESCRIPTION

A vehicle with rear doors that coordinate with a narrow wake shape and rotate visually concentric with the rear axle and move largely in envelope with sensors warning of interference with obstructions during travel.

A vehicle that uses an eye datum to locate all drivers with a command view of both pedestrians and the road in front of the vehicle. By setting all driver's eyes at an identical location the need for other adjustments is eliminated: rear view mirrors can be fixed in position, as can head up display settings, air bag locations and window controls. Additionally the fixed eye location allows the use of split A-Pillars for additional forward view, as view direction is known, and bulky B-Pillars that contain air-conditioning and air bags, as the front seat never has to slide back past the B-Pillar. The seat cushion and pedals slide forward and backward to accommodate different driver heights and leg lengths.

A vehicle with two air-conditioning circuits, each of 4 passengers assigned a dedicated evaporator coil arranged in diagonal such that whether the sun is shining from the left, the front or the right each of the two circuits will only have one major load.

A vehicle with a set of externally accessible compartments, or lockers, one or more corresponding to an individual rider. These lockers can be opened with a geospatial coordinates, bar code scans, radio signatures, software encoded data streams alone or in combination. Compartments may additionally be accessible from inside the vehicle for privacy or weather protection purposes.

### BRIEF DESCRIPTION OF THE DRAWINGS

FIG. 1 is a drawing showing the variation in blind spots based on two different seating positions that occur when the driver's feet are anchored to the firewall.

FIG. 2a is a drawing showing how pedals and seat cushion move to accommodate a standard position for the driver's eyes. FIG. 2b also shows how the eye datum, by limited the rearward travel of the front seat protects the space of the rear passengers, protects space to accommodate air conditioning in the B-Pillars, buts all the people on the front seat on equal fore and aft position—one is not in front of the other. The dual diagonal nature of the air conditioning is also illustrated in FIG. 2b.

FIG. 3 is a logic flow diagram showing one logical sequence to fix the position of the driver's eyes independent of physical stature.

FIG. 4 is a drawing showing one possible location of externally accessible locker doors.

FIG. 5 is a drawing showing the rotating rear door fully opened and partially opened.

### DETAILED DESCRIPTION

The embodiments described herein provide aspects of a high occupancy vehicle for workday commutes. The vehicle has a mechanism for locating the eyes of all drivers at an identical position thus assuring good a uniform view of the environment inside and outside the vehicle.

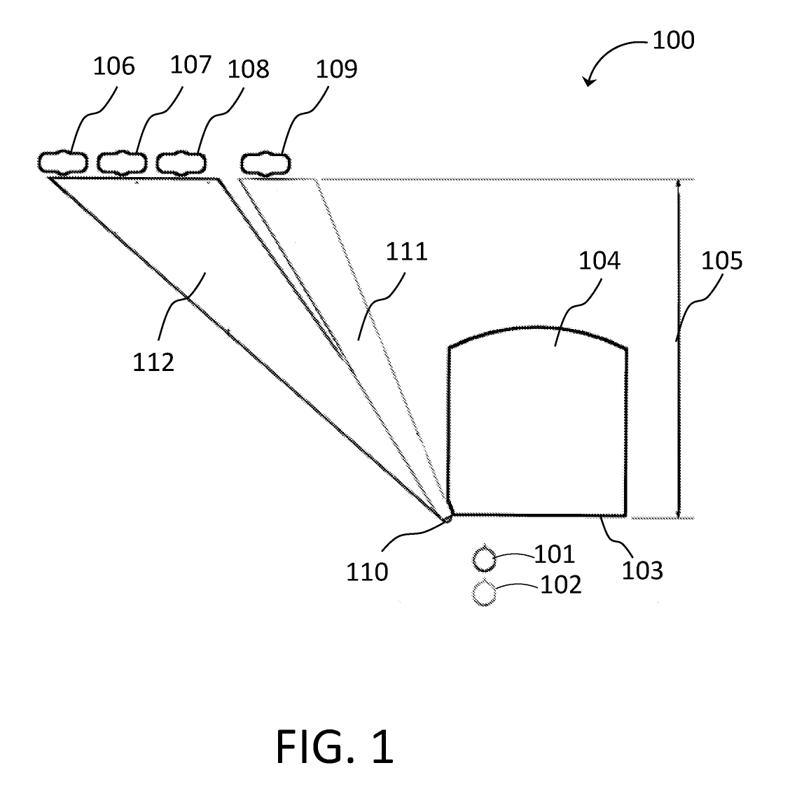

FIG. 1 is atop view of the visual environment 100 in front of a vehicle. There are two driver positions: 101 for a shorter driver and 102 for a taller driver. Each is located by leg length off the pedals at the firewall 103. The hood of the vehicle 104 occupies a fraction of the distance 105 between the firewall and the pedestrians 106, 107, 108, 109. The A-Pillar 110 obscures the driver's view of pedestrians. The blind spot for a tall person 111 obscures one pedestrian 109. The blind spot for a shorter person 112 is much larger, obscuring three pedestrians 106, 107, and 108. This figure illustrates one set of problems with locating driver's eyes based on leg length off pedals at the firewall. Other include airbag force and timing as well as the need to provide adjustment to head up displays and rear view mirrors to accommodate different driver head positions.

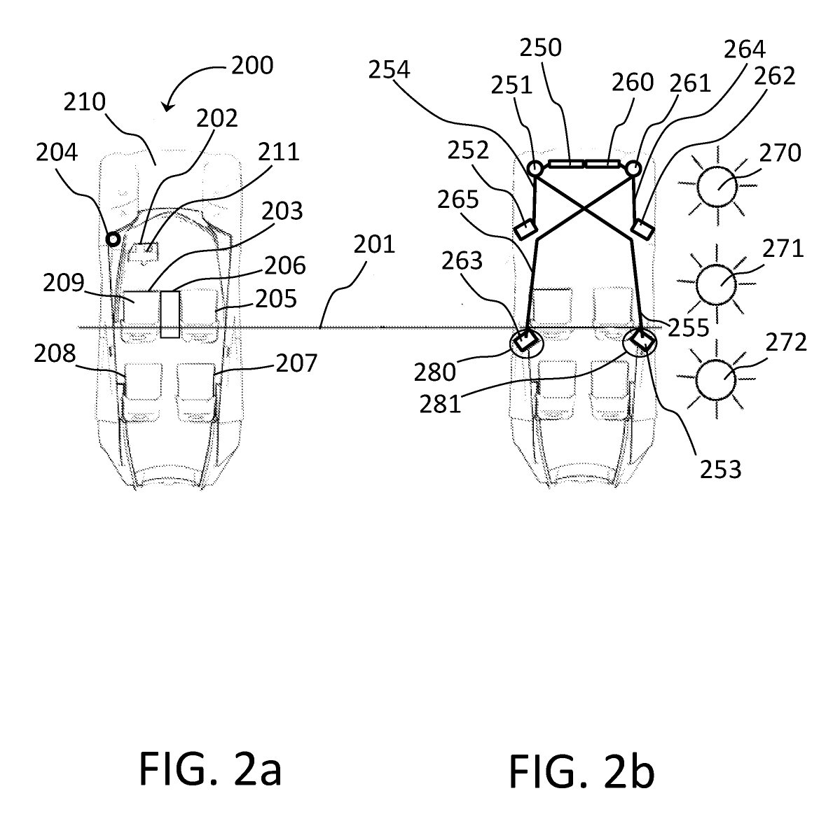

FIG. 2a is a top view of a vehicle 200 that uses an eye datum 201 enabled by a moving pedal assembly 202 to maintain the driver seat 203 positioned always the same distance away from the vehicle structure including the A-Pillar 204, referenced as 110 in FIG. 100. Front passenger seats 205 and optionally 206 are in a peer arrangement, one not in front of or behind the other, with the driver's seat 203 without regard to how tall or short the driver is. Rear seats 207 and 208 have protected leg room as the fixed eye position of the front seats 203, 205 and 206 limits rearward travel of those seats.

Adjustments are made in the driver's seat 203 by first setting the cushion 209 height so that drivers of all sizes can see over the hood 210, and adjusting the pedal assembly 202 to obtain a safe pressure on the pedals 211. The seat cushion 209 can then be adjusted forward and upwards along an arc centered at the driver's eyes to obtain a desired degree of recline without lowering the driver's eyes. Pedal assembly 202 can move automatically using force feedback or an estimate of lower leg length, or manually, to maintain the capability for safe pedal pressure. In automatic driving mode the pedals can move out of the way for more driver comfort.

FIG. 2b shows the elements of two independent air-conditioning circuits. The condenser 250, compressor 251, driver evaporator 252 and diagonal rear passenger evaporator 253 are connected as one system using loops 254 and 255 in a manner similar to modern refrigerators that use a single compressor to control two separate cooling loops, one for the refrigerator and one for the freezer. The condenser 260, compressor 261, front passenger evaporator 262 and diagonal rear passenger evaporator 263 are connected as one system using loops 264 and 265 in a similar manner.

The arrangement loads each compressor condenser combination with a single evaporator cooling load as the solar load, shown as the suns 270, 271 and 272, clocks from the passenger side to the front or to the left. This arrangement assures that each passenger has direct and effective control of their environment.

The eye datum 201 allows for large section B-Pillars 280 and 281 that enhance safety while accommodating large effective cooling elements 253 and 263.

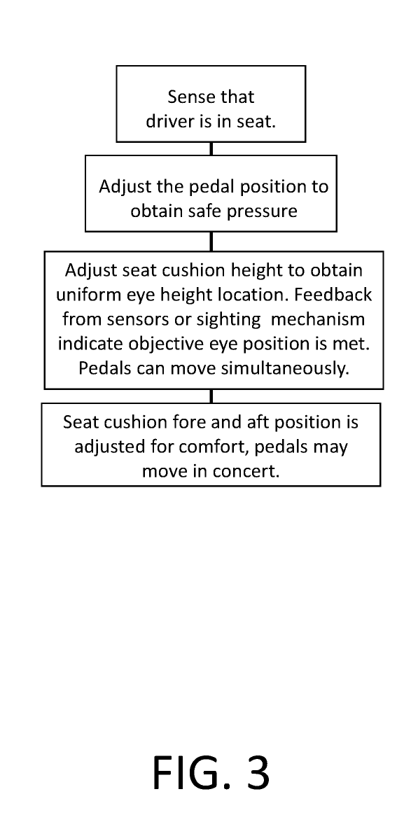

FIG. 3 shows the sensor and software logic required to automatically position drivers of any stature with their eyes in an identical position. This order is one of many possible orders. Steps can be manual or automatic.

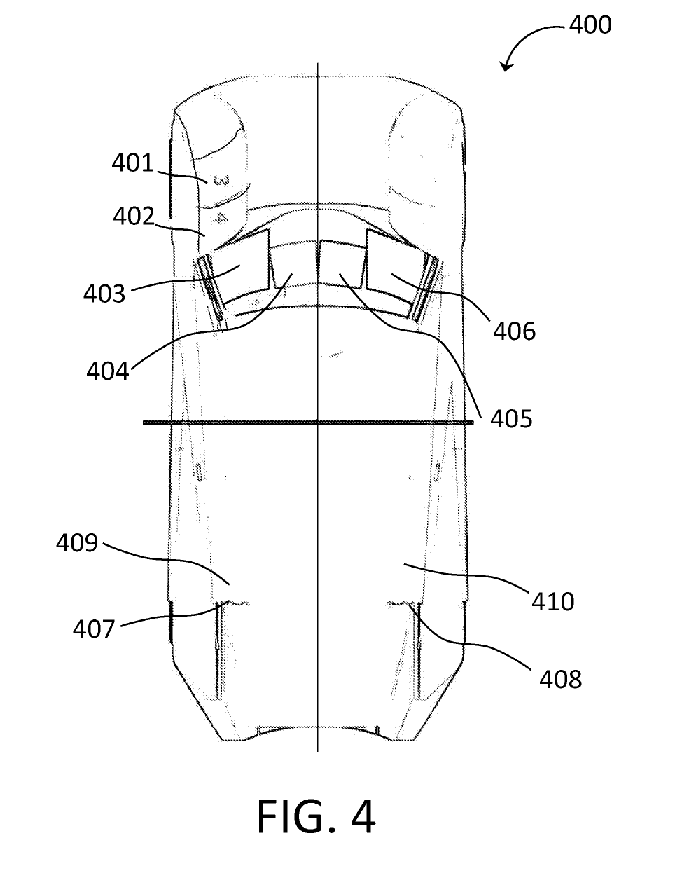

FIG. 4 is a top view of the high occupancy vehicle. Representative externally accessible lockers 401 and 402 assigned to passengers. These and similar doors allow the vehicle to become a drop off destination while parked at work, and an autonomous item pick up vehicle that can run errands during the day. Doors can be unlocked by a variety of methods including location, bar code scan using on vehicle camera, radio frequency encoding, much like a garage door opener or any combination of know locking mechanisms—biometric, the list is too ling for inclusion here.

Head up display projectors for each of four seating positions are shown as 403, 404, 405 and 406.

Aerodynamic features that help define the scale of the turbulence at the trailing edge of the doors are shown as 407 and 408. These set the scale of turbulence in the wake by use of variable cavity depth or variable shear layer support length, or a combination of the two. Benefits are that the wake closing features can be formed from the trailing edge of a sheet of glass 409 410 for a smooth low maintenance aerodynamic device.

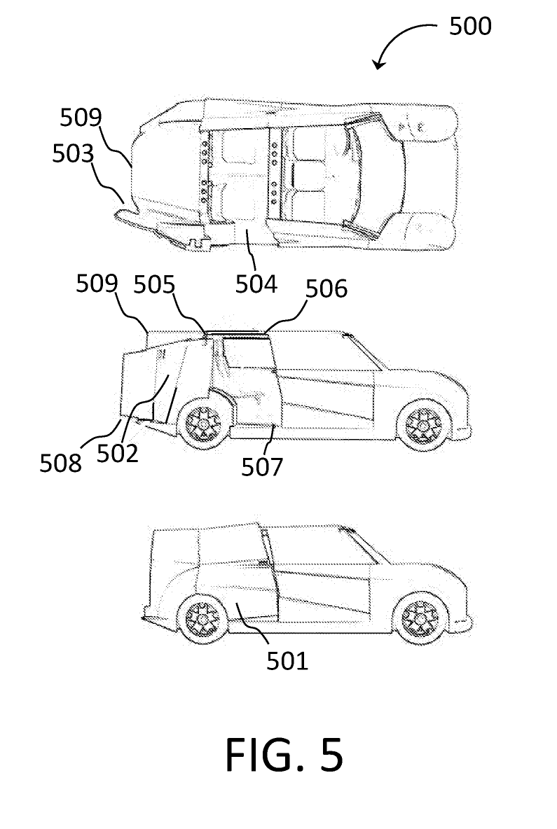

FIG. 5 is a drawing showing the rotating rear door fully opened and partially opened. 501 is the door slightly open with no interference with any body parts. 502 is the door fully open in a side view. The top view shows the door fully open with 503 showing how the door coordinates with the narrow wake of the vehicle. A weather protected footstep 504 is exposed when the door is opened. The closing door motion which is orthogonal to the pressure forces allows for tooling post positioning of the door at 505, 506 and 507. This should reduce wind noise as aerodynamic pressure forces will not appreciably change the compression of the door seals. 508 shows the tip of the door in the position to be checked with a camera before the door is allowed to fully open. 509 is one possible position for that camera.

What is claimed is:

1. Software and mechanisms that position a vehicle seat to obtain a driver, or other occupant, eye position at a uniform distance from the A-Pillar and other fixed elements of the vehicle chassis while also fixing the eye position in a narrow height range.

2. A vehicle in accordance with claim 1, wherein software, sensors and mechanisms help position a vehicle seat to obtain a driver, or other occupant, eye position in a narrow fore and aft range.

3. A vehicle in accordance with claim 2, wherein software, sensors and mechanisms help position vehicle pedals fore and aft to obtain a reliable human vehicle control interface.

4. A vehicle in accordance with claim 1, wherein a secondary backup sensor acts to prevent accidental spine damage.

5. A vehicle in accordance with claim 1, wherein a dual diagonal vehicle cooling system is used to obtain controlled temperatures.

6. Software control of multiple locker doors on the external surface of an autonomous vehicle.

7. A vehicle in accordance with claim 6, wherein a camera scanned barcode unlocks the locker.

8. A vehicle in accordance with claim 6, wherein a geospatial coordinate match opens the locker and reminds the user when the vehicle stops to drop off the owner of the locker.

9. A vehicle including a door that rotates largely concentric with the rear axle to open.

10. A vehicle in accordance with claim 9, that controls the scale of the turbulence in a wake by using varied cavity depths under a pane of glass

11. A vehicle in accordance with claim 9, wherein the action of the door closing engages tooling posts that support the door in a direction orthogonal to the pressure forces on the door.

12. A vehicle in accordance with claim 9, wherein software is used to keep the door from striking objects during the act of opening.
